(19) United States
(12) Patent Application Publication
(10) Pub. No.: US 2008/0036234 A1
(43) Pub. Date: Feb. 14, 2008

(54) Tonneau cover apparatus for vehicles

(75) Inventors: Hiroshi Yokoyama, Yokohama-shi (JP); Kazunori Saito, Yokohama-shi (JP); Yoshihisa Kurosaki, Yokohama-shi (JP)

Correspondence Address: OLIFF & BERRIDGE, PLC, P.O. BOX 320850, ALEXANDRIA, VA, 22320-4850, US

(73) Assignee: NHK SPRING CO., LTD., YOKOHAMA-SHI (JP)

(21) Appl. No.: 11/882,670

(22) Filed: Aug. 3, 2007

(30) Foreign Application Priority Data
Aug. 10, 2006 (JP) 2006-218616

(51) Int. Cl. B60R 5/04

(52) U.S. Cl. 296/98

(57) ABSTRACT

A tonneau cover 101 which covers a luggage compartment is composed of a sheet member 102 and a plate member 103 which is foldable. The sheet member 102 is rolled up in a housing 107 so as to stow it, and the plate member 103 is placed on the housing 107 by folding. Thus, storage space for the tonneau cover 101 can be reduced. A lock mechanism by which the plate member 103 is maintained in an extended condition is used so that the end of the plate member does not hang down into the luggage compartment.

### BACKGROUND OF INVENTION

1. Technical Field

The present invention relates to a tonneau cover apparatus that covers a luggage compartment of a vehicle such as a passenger car.

2. Background Art

A luggage compartment, at the rear of a vehicle such as a compact car with a hatchback, mat be covered with a covering member called a “tonneau cover” on the upper side, so as to cover the inside of the luggage compartment from outside. Since the luggage compartment provided in a hatchback is narrow or has no storage space for a tonneau cover, a structure has been suggested in which a tonneau cover has a sheet structure and can be rolled up (for example, refer to Japanese Unexamined Patent Application Publications Nos. 2000-220888 and 2000-220889).

In view of design, there is a trend for the rear of compact cars to have rounded shapes. In this case, the wall of the rear of a luggage compartment has a rounded shape, and the edge at the rear of the tonneau cover is required to have a shape that fits thereto.

If a tonneau cover is composed of a sheet member and has a rounded shape at the rear thereof, when the tonneau cover is extended (i.e., is spread out), the edge at the rear thereof should be supported so as not to hang down. In the case of a hatchback structure, since the rear door is raised back like a trapdoor, it is undesirable that the structure have a tonneau cover engaged to the rear door for supporting itself (for example, a structure in which a tonneau cover is suspended by the inside of the rear door and is stretched). Therefore, when the tonneau cover has a rounded shape at the rear thereof, a structure has been suggested so as to maintain the tonneau cover in an extended condition. In this structure, the rounded portion is composed of a plate member, which is rigid, and the other portion is composed of a sheet. Such a structure is disclosed in Japanese Unexamined Patent Application Publications Nos. 2000-220888 and 2000-220889, for example.

In the structures that are disclosed in the above patent documents, the rounded portion of a tonneau cover is rigid, whereby the rounded portion cannot be rolled up like a sheet member. Therefore, when the tonneau cover is folded, the rounded portion of the tonneau cover projects toward the luggage compartment. This makes the luggage compartment narrow and is undesirable. Specifically, since a luggage compartment of a compact car is narrow, this problem is conspicuous. In the structures that are disclosed in the above patent documents, when the tonneau cover is folded, the leading end of the tonneau cover is positioned at the rear side (inside of a vehicle body) viewed from the leading direction. Therefore, if a small person handles the tonneau cover that is folded, the end thereof may be difficult to reach and may be difficult to handle.

### SUMMARY OF THE INVENTION

In a structure having a rounded shape at the rear of a tonneau cover (at the rear side of a vehicle), an object of the present invention is to provide a structure which supports a structure having a rounded shape when a tonneau cover is extended, which does not take up a large amount of space when the tonneau cover is folded, and which is easy to handle.

The present invention provides a tonneau cover apparatus for vehicles, which comprises a sheet member, a housing for stowing the sheet member in a rolled up condition, a first plate member affixed to a leading edge of the sheet member, a second plate member having a side edge which is connected to the first plate member via a hinge, and a supporting structure for maintaining the first and the second plate members in an extended condition on approximately the same surface. A lower surface of the second plate member is disposed on a lower surface of the first plate member, and an upper surface of the first plate member is disposed on an upper surface of the housing, so that the first and the second plate members are folded over each other. When the first and the second plate members are folded, another side edge opposite to the side edge of the second plate member is placed at the leading direction of the sheet member.

Note that the upper surface is the upper surface in the vertical direction, and the lower surface is the lower surface in the vertical direction, when the first and the second plate members are flatly extended. Depending on design and structure of the inside of a vehicle body, the first and the second plate members may not be flatly extended and may not be level. In this case, the surface facing upwardly in the vertical direction is defined as the upper surface, and the surface facing downwardly in the vertical direction is defined as the lower surface.

According to the present invention, a sheet member may be rolled up so as to be stowed, whereby storage space for the tonneau cover can be reduced. Moreover, a plate member is affixed to a leading edge of the sheet member, whereby the shape of the tonneau cover may be selected according to the shape of the rear of a vehicle body. Furthermore, when the tonneau cover is folded, the plate member is folded and is placed on the housing of the sheet member, whereby the storage space for the plate member can be made compact. That is, according to the present invention, the storage space for the tonneau cover can be reduced, whereby a luggage compartment may be wider.

The present invention provides a tonneau cover apparatus for vehicles, which comprises a sheet member, a housing for stowing the sheet member in a rolled up condition, a first plate member affixed to a leading edge of the sheet member, a second plate member connected to the first plate member via a connecting member composed of a flexible sheet material, and a supporting structure for maintaining the first and the second plate members in an extended condition on approximately the same surface. A lower surface of the second plate member is disposed on a lower surface of the first plate member, and an upper surface of the first plate member is disposed on the upper surface of the housing, so that the first and the second plate members are folded with each other. When the first and the second plate members are folded, another side edge opposite to the side edge of the second plate member is placed at a leading direction of the sheet member.

According to this structure, the first and the second plate members are connected (i.e., are joined) by a flexible sheet material, which is made from a fabric or a resin sheet. The flexible sheet material functions as a connecting member by bending. For example, the first and the second plate members are covered with a fabric, which is affixed thereto by sewing, welding, or adhering at the periphery and the folding line, so as to obtain the structure. The structure has advantages in cost, productivity, weight, design, etc. Note that the sheet member and the flexible sheet material may be made from different materials or from the same material. Moreover, the sheet member and the flexible sheet material may be composed of an undivided sheet member. In addition to the connecting member composed of the flexible sheet material, a hinge shaft and a hinge may be provided so as to connect the first and the second plate members.

According to the present invention, a handle is placed on another side edge opposite to the side edge of the second plate member. When the tonneau cover is folded, the handle is preferably placed at a leading direction of the sheet member. According to this aspect, when the tonneau cover is folded, the handle is placed at the front side of the leading direction, whereby the tonneau cover is easily extended and is easily folded. Specifically, when the tonneau cover is folded, the handle is placed on the second plate member at the rear side of a vehicle body. Therefore, when the tonneau cover is opened and is closed from the rear side of a vehicle body such as one having a hatchback structure, the handle can be placed so that it is easy to grab.

The present invention is suitable for use in vehicles having a rounded shape at the rear of the body. In this case, a leading edge of a plate member has a rounded shape. Even when the leading edge of a plate member has a rounded shape, the present invention provides a supporting structure for maintaining the plate member in an extended condition, whereby the plate member, which is extended, will not bend and will not hang down.

In the present invention, the plate member is folded at a hinge, and a supporting structure for maintaining the plate member in an extended condition preferably has a lock mechanism, which maintains the hinge in an opened condition. According to this aspect, when the plate member is extended from the folded state, the hinge is opened and is locked, whereby the plate member is maintained in an extended condition. Therefore, the plate member, which is extended, does not hang down.

In the present invention, as a supporting structure for maintaining the plate member in an extended condition, a structure may comprise a supporting member, which upwardly supports the second plate member. According to this aspect, when the plate member is extended, the second plate member is supported by the supporting member, and it does not hang down.

In the present invention, the lower surfaces of the first and the second plate members have a fastener with hooks and loops. When these plate members are folded, the first and the second plate members are preferably adhered by the fastener with hooks and loops. According to this aspect, when the first and the second plate members are folded, they are easily affixed to each other, and they may be easily detached. Moreover, when the tonneau cover is extended, the fastener with hooks and loops is on the lower surface thereof, whereby the fastener with hooks and loops is hidden, and the design of the tonneau cover is not degraded.

According to the present invention, the tonneau cover is composed of a sheet member and a plate member that is foldable. When the tonneau cover is folded, the plate member which is folded is placed on a housing, in which the sheet member is rolled up. Therefore, the rear of the tonneau cover (rear of a vehicle body) can have a rounded structure, and it will not need a large space for stowing when it is folded. Moreover, when the tonneau cover is folded, a portion to pull (an edge portion to pull) of the second plate member is placed on the rear of a vehicle body, whereby the tonneau cover is easily folded and expanded.

### BRIEF DESCRIPTION OF DRAWINGS

FIGS. 1A to 1C are perspective views showing an example of a tonneau cover apparatus using the present invention.

FIGS. 2A to 2C show an example of a tonneau cover using the present invention, wherein FIG. 2A is a top view, and FIGS. 2B and 2C are sectional views.

FIGS. 3A and 3B show another structure of a plate member, wherein FIG. 3A is a top view and FIG. 3B is a sectional view.

FIGS. 4A and 4B are sectional views showing an example of a hinge.

FIG. 5 is a sectional view showing an example of a hinge.

FIG. 6 is a sectional view showing an example of a hinge.

FIGS. 7A to 7C show an example of a hinge, wherein FIG. 7A is a side view, and FIGS. 7B and 7C are sectional views viewed from an axial direction.

FIGS. 8A to 8C show an example of a hinge, wherein FIG. 8A is a side view, and FIGS. 8B and 8C are sectional views viewed from an axial direction.

FIGS. 9A and 9B show an example of a hinge, wherein FIG. 9A is a top view and FIG. 9B is a sectional view.

FIGS. 10A and 10B show an example of a supporting structure, wherein FIG. 10A is a top view and FIG. 10B is a sectional view.

FIGS. 11A and 11B are sectional views showing an example of a supporting structure.

### PREFERRED EMBODIMENTS OF THE INVENTION

### 1. First Embodiment

### Overall Structure

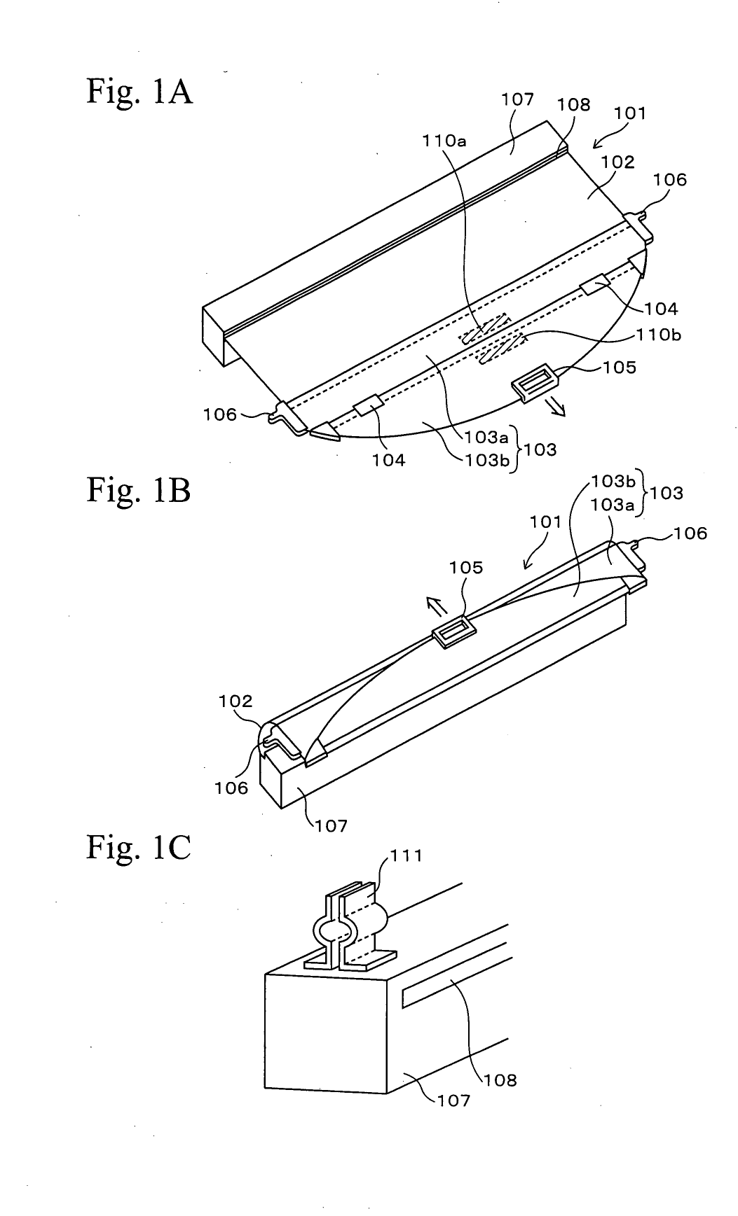

An example is explained in the following. The present invention may be used for a tonneau cover of a passenger car with a hatchback which has a rounded shape at the rear. FIGS. 1A to 1C are perspective views showing an example of a tonneau cover according to the present invention. FIG. 1A is a perspective view showing a tonneau cover which is in an extended condition (a tonneau cover which is pulled out to cover a luggage compartment), FIG. 1B is a perspective view showing a tonneau cover which is folded, and FIG. 1C is a partially enlarged perspective view.

As shown in FIG. 1A, a tonneau cover 101 comprises a sheet member 102 and a plate member 103 which is affixed to the leading edge of the sheet member. The sheet member 102 is composed of a flexible sheet such as a fabric and a resin sheet. The plate member 103 is composed of a first plate member 103a and a second plate member 103b. In this structure, the first plate member 103a is affixed to the leading edge of the sheet member 102, and the second plate member 103b is affixed to the opposite side of the edge (the leading edge), in which the first plate member 103a is affixed to the sheet member 102, via a hinge 104. According to this structure, the tonneau cover is extendable (FIG. 1A), and is foldable (FIG. 1B). The hinge 104 has a lock mechanism which locks (fixes) the open state, when it is opened from the closed state. This lock mechanism will be explained later.

The first plate member 103a and the second plate member 103b have a structure, in which a fabric or a resin sheet for decoration is affixed to both sides of a cardboard (paper board) sheet, and they have some degree of rigidity and are light in weight. As a material for the plate member, besides the cardboard, a material reinforced by glass fiber or PP (polypropylene) fiber may be used.

The second plate member 103b has a rounded shape (curved shape) at the leading edge of the tonneau cover 101 (direction of the wide arrow). The rounded shape corresponds to the shape of the rear of the luggage compartment provided at the rear of a passenger car (not shown in the figure). The second plate member 103b comprises a handle 105, which is gripped by a hand so as to pull out the tonneau cover 101, near the edge of the rounded shape. The first plate member 103a is provided with an engaging part 106 at both ends in the width direction. The engaging part 106 is engaged to a receiving part of a vehicle body (not shown in the figure), whereby the tonneau cover 101 is maintained in an extended condition. The engaging part 106 is horizontally supported by a vehicle body (not shown in the figure). When the engaging part 106 is engaged to the vehicle body, the first plate member 103a is horizontally supported by a member of the vehicle body.

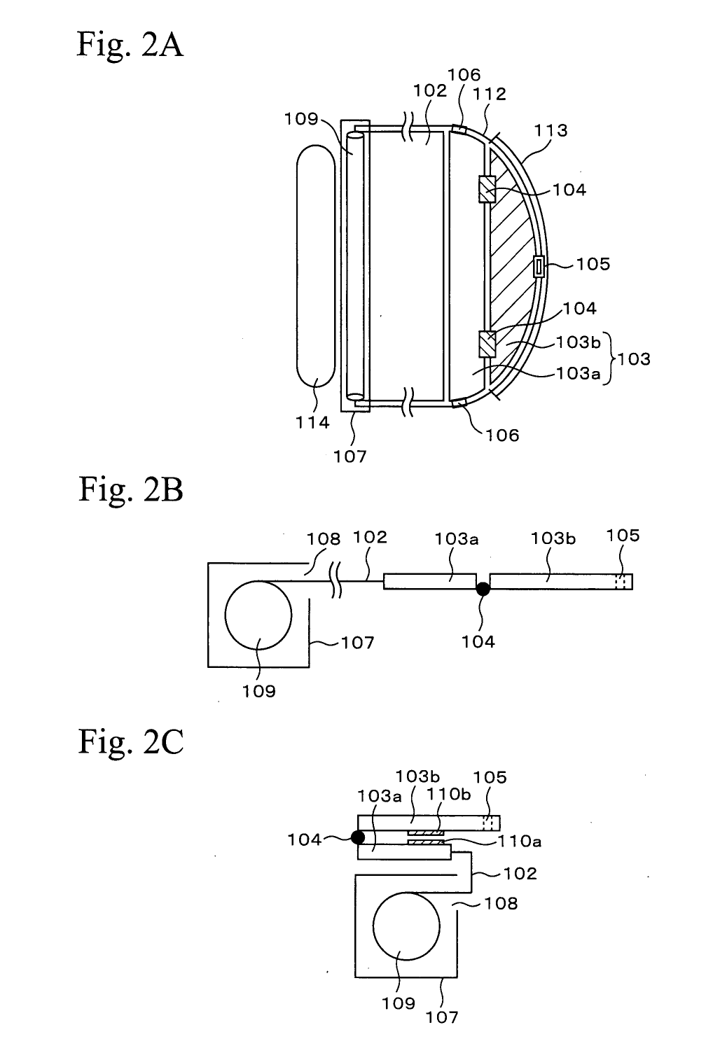

The sheet member 102 is stowed in the housing 107 by rolling it up. The housing 107 has a shape of an approximately square pillar, and has a slit 108 from which the sheet member 102 is pulled out. FIG. 2A is a top view in which a state shown in FIG. 1A is viewed from above, FIG. 2B is a sectional view in which a state shown in FIG. 1A is viewed from the side, and FIG. 2C is a sectional view showing a tonneau cover which is rolled up. Note that FIG. 2A shows a wall surface 112 of the inside of a vehicle body, a rear door 113, and a rear seat 114.

As shown in FIGS. 2A to 2C, in the inside of the housing 107, a rolling shaft 109 is placed so that the sheet member 102 is rolled up thereat. The rolling shaft 109 is biased to the rolling direction by a biasing means (not shown in the figure), and the sheet member 102 is automatically rolled up thereat. For example, the biasing means may be composed of a torsion coil spring.

On the lower surfaces of the first plate member 103a and the second plate member 103b, a fastener with hooks 110a and loops 110b is disposed. When the first plate member 103a and the second plate member 103b are folded, they are adhered to each other by the fastener with hooks and loops. As shown in FIG. 1C, on both ends of the upper surface of the housing 107, hooks 111 for engaging the engaging part 106 are disposed. Therefore, when the plate member 103 is folded, the engaging part 106 is engaged to the hooks 111, and the plate member 103 which is folded, is affixed on the housing 107. The hooks 111 are not shown in FIG. 1B.

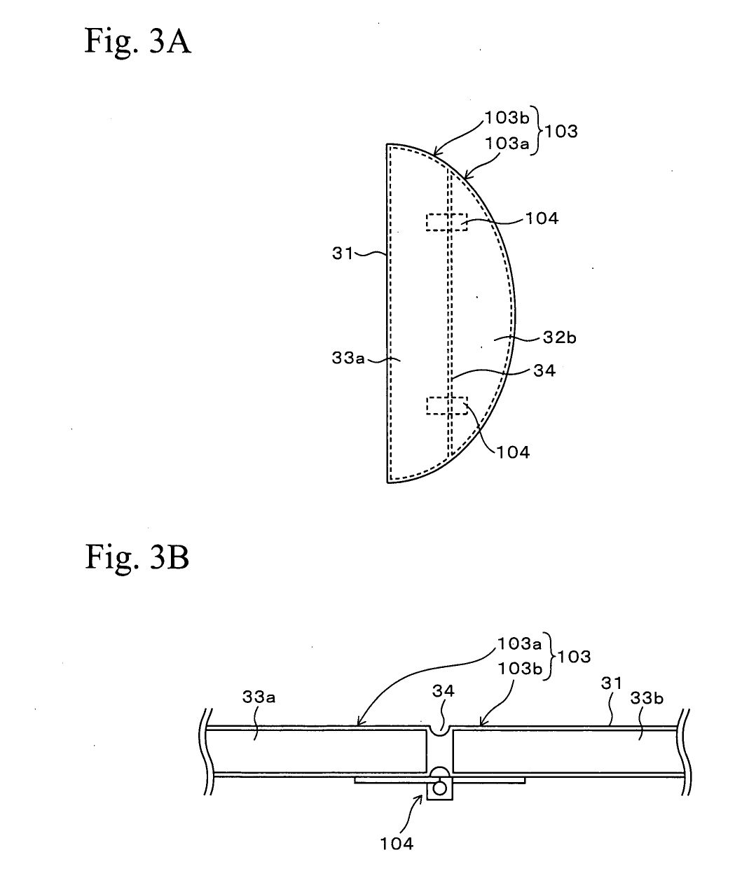

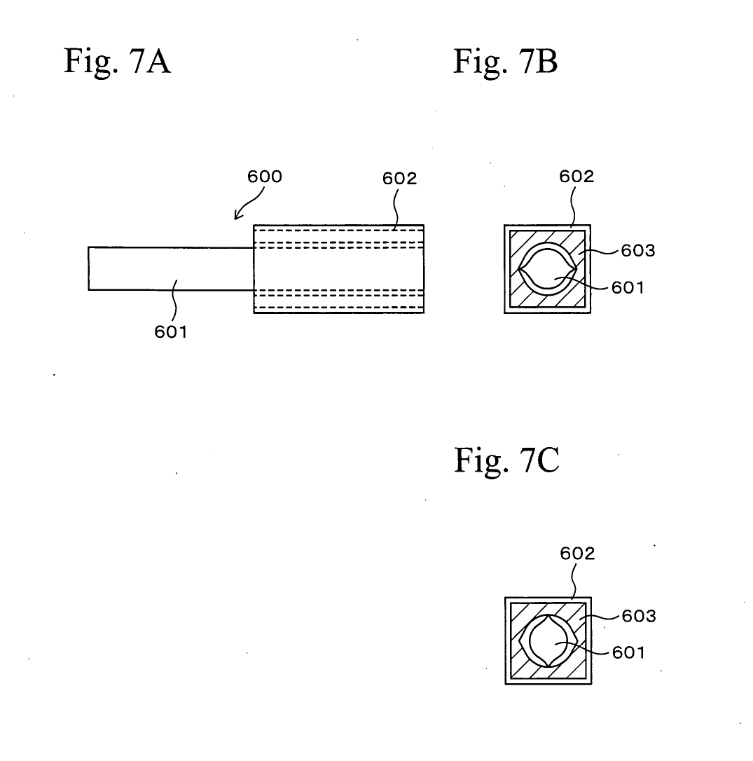

As another structure of the plate member 103, a structure shown in FIGS. 3A and 3B may be mentioned. FIGS. 3A and 3B show an example of another structure of the plate member 103, wherein FIG. 3A is a top view, and FIG. 3B is a side sectional view. In the structure shown in FIGS. 3A and 3B, the first plate member 103a and the second plate member 103b are connected. A board 33a, which is a frame of the first plate member 103a, and a board 33b which is a frame of the second plate member 103b, are covered with a fabric 31 by sewing the periphery and folding line 34. The plate member 103 is foldable at the folding line 34, which functions as a connecting member. The plate member 103 is maintained in an extended condition by a hinge 104 which is the same as in FIG. 1A. In this case, the hinge 104 may have any of the structures shown in FIGS. 7A to 9B. The fabric 31 may be composed of a resin material, and it may be welded by a high-frequency welder instead of by sewing. Moreover, the fabric 31 is bonded by a setting adhesive instead of by sewing. The board 33a and 33b may be composed of a material reinforced by a cardboard, glass fiber, or PP (polypropylene).

### Basic Function

FIG. 1B shows a tonneau cover 101 that is folded. When the tonneau cover 101 is folded, the sheet member 102 is rolled up in the housing 107. The plate member 103 is folded, and it is placed on the housing 107. The plate member 103, which is folded, is affixed on the housing 107, and it is maintained in a folded condition by hooks 111 and a fastener with hooks 110a and loops 110b shown in FIG. 1C.

In the tonneau cover 101 which is folded and is shown in FIG. 1B and FIG. 2C, when the handle 105 is grasped and is lifted by hand from the rear of a vehicle, the second plate member 103b, which is adhered to the first plate member 103a by the fastener with hooks 110a and loops 110b, is unfastened. Moreover, when the handle 105 is pulled toward the front side (rear of the vehicle, in the direction of the wide arrow shown in FIG. 1B), the engaging part 106 is disengaged from the hook 111 shown in FIG. 1C, and the first plate member 103a affixed on the housing 107 is detached. The sheet member 102 is rolled up in the housing 107 by a bias force of a bias means (not shown in the figures). Therefore, when the handle 105 is pulled further, a force for flattening (leveling) the plate member 103 is produced, which opens the hinge 104. After the hinge 104 is opened, it is locked by a lock mechanism which is described later. Accordingly, the plate member 103 has some degree of rigidity in an open state.

Furthermore, when the handle 105 is pulled by a force greater than the bias force of rolling, the sheet member 102, which is rolled up in the housing 107, is pulled out and is extended. Then, the engaging part 106 is engaged with a receiving part (not shown in the figure), so as to maintain the sheet member 102 in an extended condition (the state shown in FIG. 2A).

In this state, the sheet member 102 is stretched by a bias force of pulling to the housing 107, and covers the top of a luggage compartment. The first plate member 103a is stretched toward the housing 107 by a bias force of rolling, and is horizontally maintained by a vehicle body (not shown in the figure). Moreover, the hinge 104, which is horizontally opened, is locked. Therefore, the second plate member 103b is horizontally maintained alongside the plate member 103a. That is, the plate member 103 is horizontally maintained without hanging down.

In the state shown in FIG. 1A, in order to fold the tonneau cover 101, the handle 105 is grasped to pull it a short distance, or to pull it a short distance and lift it, so that the engaging part 106 is disengaged from a vehicle body (not shown in the figure). The sheet member 102 is stretched by a bias force of pulling to the housing 107. Therefore, after disengaging the above engagement, when the handle 105 is pushed toward the front side of a vehicle (opposite to the direction of the wide arrow in FIG. 1A) by grasping by hand, the sheet member 102 is rolled up into the housing 107 by the above bias force.

When the sheet member 102 will not be rolled up into the housing 107 any further, the hinge 104 is folded by bending as shown in FIG. 2C. That is, the first plate member 103a and the second plate member 103b are bent into peaks (inverted V shape), and is folded so that the lower surfaces thereof face each other. Then, the plate members which are folded, are pushed down (are turned over) toward the rear seat 114, and the upper surface of the second plate member 103b (the upper surface shown in FIG. 1A) is placed on the top face of the housing 107. In this case, the engaging part 106 fits to a hook 111 shown in FIG. 1C, and the first plate member 103a is affixed on the housing 107.

Thus, the tonneau cover 101 is folded as shown in FIG. 2C. In this case, the fastener with hooks 110a on the lower surface of the first plate member 103a is connected to the fastener with loops 110b on the lower surface of the second plate member 103b, and the first plate member 103a and the second plate member 103b, which are folded, are affixed. Moreover, the plate member 103, which is folded, is affixed on the housing 107 by engaging the engaging part 106 to the hook 111. In this case, the lower surface of the first plate member 103a is placed on (is faced to) the lower surface of the second plate member 103b, and the upper surface of the first plate member 103a is placed on the top of the housing 107, so that they are folded. When the plate member 103 is folded, another side edge opposite to the side edge of the second plate member 103b (the side having a handle 105) is placed at the leading direction of the sheet member 102. In this example, when the first and the second plate members are extended, they are flat and are parallel to the same flat surface. However, when the first and the second plate members are extended, they may be slightly bent instead of being parallel. Moreover, when the first and the second plate members are extended, they may be slightly inclined overall.

### Advantages of Embodiments

According to the structures shown in FIGS. 1A to 1C, even when the rear of a luggage compartment has a structure with a rounded shape, the plate member 103 which is extended is locked, whereby the tonneau cover 101 covers the top of the rear of the luggage compartment. The tonneau cover 101 is folded by rolling the sheet member 102 into the housing 107, and the plate member 103 which is folded is placed on the housing 107, whereby the structure of the tonneau cover is compact. When the tonneau cover 101 is folded, the handle 105 is positioned at the rear of a vehicle body, whereby the tonneau cover 101 is easily extended and folded, and this is convenient. Furthermore, when the plate member 103 is extended, the fastener with hooks 110a and loops 110b for maintaining the plate member 103 in a folded condition are on the lower surface thereof, whereby the fastener with hooks and loops are not conspicuous, and do not degrade the design of the tonneau cover.

### First Structure of Hinge

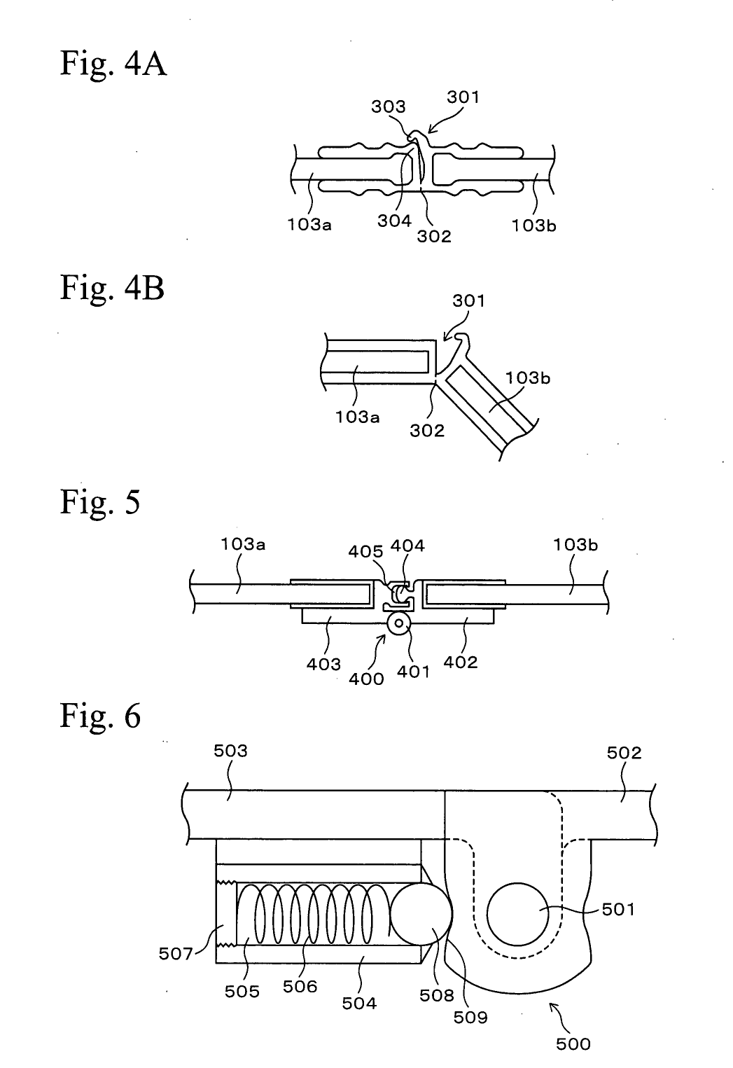

Some examples of a hinge 104 are explained hereinafter. As a primary example, a hinge is explained which is used for connecting the plate member 103 shown in FIG. 1A. However, the hinge described below may be used for a structure shown in FIGS. 3A and 3B. FIGS. 4A and 4B are sectional views showing another example of a hinge shown in FIGS. 1A and 2A to 2C. FIGS. 4A and 4B show a hinge 301 connecting a first plate member 103a and a second plate member 103b. Note that FIG. 4A shows plate members which are extended (are spread), and which are held (are locked). FIG. 4B shows plate members that are unlocked and are bent, so as to fold.

The hinge 301 is made from resin, and it is bendable at a portion indicated by a reference numeral 302 as shown in FIG. 4B. This bending is performed due to the elasticity of the resin material. The hinge 301 is provided with a claw 303 and a protruding portion 304 which engages with the claw 303. When the hinge 301 is opened from a closed state (is flattened from the bent state), the claw 303 is caught by the protruding portion 304, and they are engaged, whereby the open state is locked. Because the claw 303 and the protruding portion 304 are made from resin, when the hinge 301 is bent from the open state, it is not until an appropriate degree of force is applied that the above engagement is disengaged and that the hinge 301 is bent as shown in FIG. 4B.

### Second Structure of Hinge

FIG. 5 shows another example of a hinge 104 shown in FIG. 1A. A hinge 400 shown in FIG. 5 comprises a first member 402 and a second member 403 which are connected by a hinge shaft 401. The first member 402 is affixed to a second plate member 103b, and the second member 403 is affixed to a first plate member 103a. This structure is the same as a typical hinge.

In the hinge 400 shown in FIG. 5, the first member 402 comprises a press fitting projection 404 having a boss shape in cross section, and the second member 403 comprises a receiving portion 405 having a concave shape in which the press fitting projection 404 fits. At least one of the press fitting projection 404 and the receiving portion 405 is composed of a resin material that is slightly deformable.

When the hinge 400 is opened from a closed state (is flattened from a bent state), the press fitting projection 404 is press fitted into the inside of the concave portion of the receiving portion 405, and the first member 402 and the second member 403 are affixed to each other. In this case, at least one of the press fitting projection 404 and the receiving portion 405 slightly deforms, and the press fitting projection 404 will be press-fit into the inside of the concavity of the receiving portion 405. The press fitting projection 404 fits in the receiving portion 405, whereby the fixed state thereof is locked. Therefore, rigidity for maintaining the shape of the plate member 103, which is extended (refer to FIG. 1A), is obtained.

When the hinge 400 is bent by some degree of force, the press fitting projection 404, which fits in the receiving portion 405, is disengaged and is unlocked, whereby the first plate member 103a and the second plate member 103b can be folded.

### Third Structure of Hinge

FIG. 6 is another example of a hinge 104 shown in FIG. 1A. The hinge 500 shown in FIG. 6 comprises a first member 502 and a second member 503 connected by a hinge shaft 501. The first member 502 is affixed to a second plate member 103b (not shown in the figure) (refer to FIG. 1A), and the second member 503 is affixed to a first plate member 103a (not shown in the figure) (refer to FIG. 1A). This structure is the same as the previously described hinge.

The hinge 500 shown in FIG. 6 is composed of the second member 503, which comprises a pressing base 504. The pressing base 504 comprises a cylindrical space 505, in which a coil spring 506 is placed. One end in the axial direction of the cylindrical space 505 is closed by screwing a cap 507, and the other end has a metal ball 508, which is outwardly biased by the coil spring 506. In the first member 502 which composes the hinge, a concave portion 509 is formed at the portion pressed by the metal ball 508, which is biased as mentioned above.

FIG. 6 shows a hinge 500, which is opened and is locked. The hinge 500 is locked by the metal ball 508, which is pressed to the concave portion 509 by the bias force of the coil spring 506. When the hinge 500 is bent by adding force, the metal ball 508 pushes back the coil spring 506, whereby the first member 502 rotates around a hinge shaft 501 as an axis against the second member 503. Accordingly, the hinge 500 can be folded.

### Fourth Structure of Hinge

FIGS. 7A to 7C show another example of a hinge 104 shown in FIG. 1A. FIG. 7A is a side view, and FIG. 7B and FIG. 7C are sectional views taken from a direction perpendicular to an axis. A hinge 600 shown in FIG. 7A comprises a shaft 601 and a case 602. The shaft 601 is affixed to one plate member which is foldable, and the case 602 is affixed to the other plate member (not shown in FIGS. 7A to 7C).

FIG. 7B shows a state in which a hinge 600 is locked, and FIG. 7C shows a state in which a shaft 601 is being rotated. The shaft 601 has a noncircular shape (in this example, a shape of a cross section of a lemon) as shown in FIG. 7B. The inside of the case 602 is filled with an elastic material (for example, a rubber material and a resin material) 603 that is deformable, and is provided with an internal space that fits to the cross-section shape of the shaft 601.

In FIG. 7B, the shaft 601 is supported by the elastic material 603, and hardly rotates (that is, it is locked). When the shaft 601 is be rotated against the case 602 by applying force, the elastic material 603 deforms by applying the appropriate degree of force, and the shaft 601 will rotate (for example, the state is shown in FIG. 7C). The plate member 103 shown in FIG. 1A may be maintained (be locked) in an extended condition by using this structure.

### Fifth Structure of Hinge

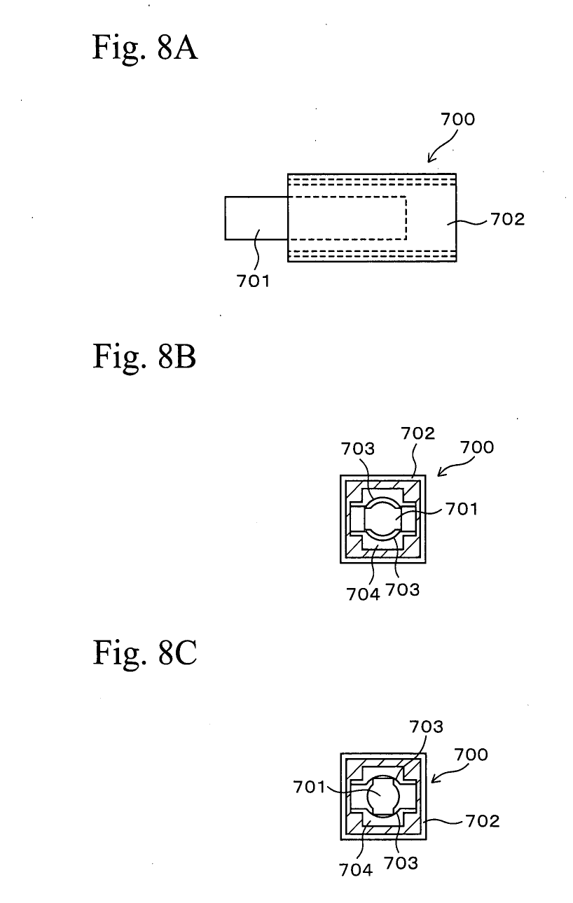

FIGS. 8A to 8C show another example of a hinge 104 shown in FIG. 1A. FIG. 8A is a side view, and FIGS. 8B and 8C are sectional views taken from a direction perpendicular to an axis. A hinge 700 shown in FIGS. 8A to 8C comprises a shaft 701 and a case 702. The shaft 701 is affixed to one plate member which is foldable, and the case 702 is affixed to the other plate member (not shown in FIG. 8A).

FIG. 8B shows a state in which hinge 700 is locked, and FIG. 8C shows a state in which a shaft 701 is being rotated. The shaft 701 has a noncircular shape (in this example, the shape has convex portions projecting in two directions to the left and to the right in cross section) as shown in FIG. 8B. The inside of the case 702 comprises a space 704 in which a shaft 701 is rotatable. In the space 704, a pair of plate springs 703 is placed. The pair of springs 703 has a shape corresponding to the outer shape of the shaft 701 and pushes the shaft 701 from above and below.

In FIG. 8B, a shaft 701 is pushed by the pair of plate springs 703 from above and below. In this case, when the shaft 701 is rotated, the convex portions on the both sides of the shaft 701 outwardly push the pair of plate springs 703, whereby force for deforming (changing) the pair of plate springs 703 is required so as to rotate. According to this function, the shaft 701 is locked so as not to rotate. When the shaft 701 is rotated against the case 702 by applying some degree of force, the convex portions on both sides of the shaft 701 push the pair of plate springs 703, and the shaft 701 will rotate under the bias force of the pair of plate springs 703 (for example, the state is shown in FIG. 8C). The plate member 103 shown in FIG. 1A may be maintained (be locked) in an extended condition by using this structure.

### Sixth Structure of Hinge

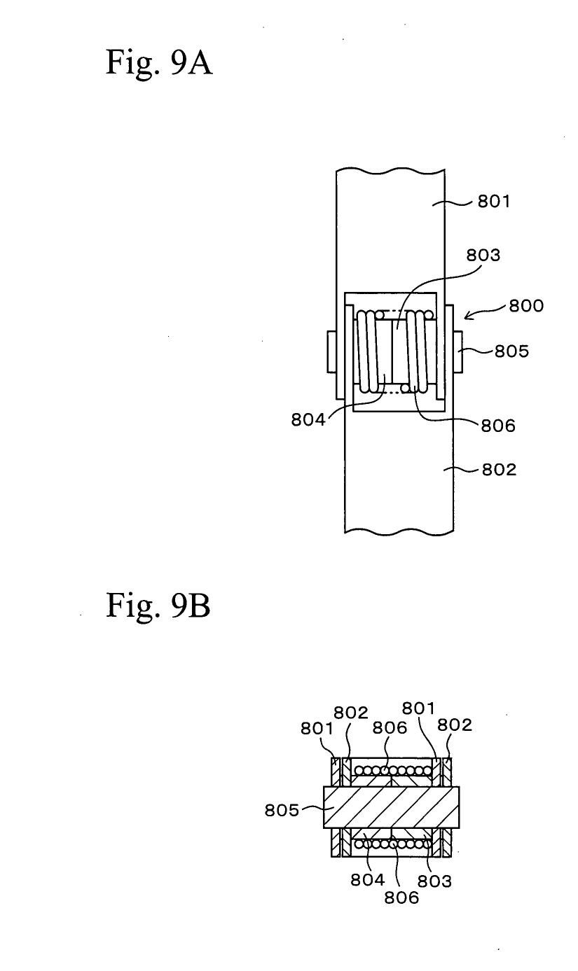

FIGS. 9A and 9B show another example of a hinge 104 shown in FIG. 1A. FIG. 9A is a top view, and FIG. 9B is a sectional view of a hinge portion shown in FIG. 9A. A hinge 800 shown in FIG. 9A has a structure in which a first member 801 and a second member 802 are connected by a hinge shaft 805.

The first member 801 is affixed with a cylindrical member 803, which is rotatably fitted to the outside of the hinge shaft 805. The second member 802 is affixed with a cylindrical member 804, which is rotatably fitted to the outside of the hinge shaft 805 next to the cylindrical member 803.

The cylindrical member 803 and 804 are forcibly fitted in the inside of a coil spring 806 which has a smaller inner diameter than that of the outer shape thereof. The coil spring 806 is compressed and is fitted between the first member 801 and the second member 802.

According to this structure, the first member 801 and the second member 802 may be locked at any open angle. That is, the coil spring 806 tightens the cylindrical member 803 and 804, which are placed side by side, from the periphery, and biases the first member 801 and the second member 802 from inside to outside. Therefore, the tightening force and the bias force produce frictional force, whereby relative motion of the first member 801 and the second member 802 having a hinge 805 as an axis are controlled (a motion in which the hinge is opened and is closed). On the other hand, when an outside force which is stronger than the frictional force is applied, the hinge can be closed and can be opened. The plate member 103 shown in FIG. 1A may be maintained (be locked) in an extended condition by using this lock mechanism.

The above descriptions are examples in which a lock mechanism is provided to a hinge, and maintains the open state thereof, so that the plate member of a tonneau cover is maintained in an extended condition, and it does not hang down.

### 2. Second Embodiment

As a means for the first plate member 103a and the second plate member 103b to be maintained flat, a structure shown in FIG. 1A is explained hereinafter. The structure comprises a supporting member extended from the plate member 103a to the lower side of the second plate member 103b, so that the second plate member 103b is supported so as not to hang down.

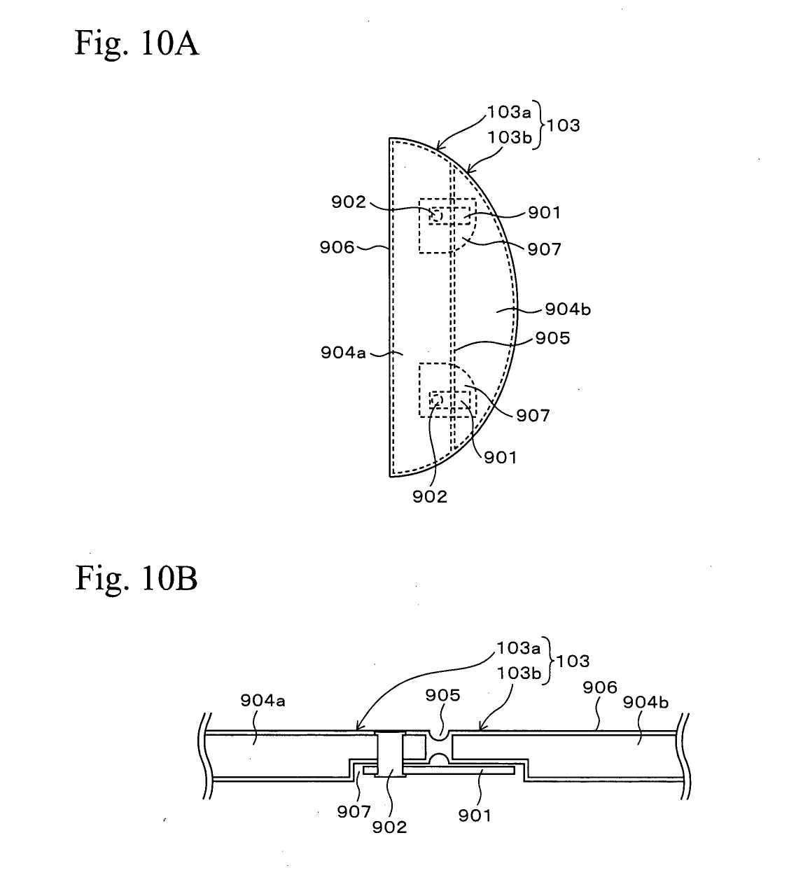

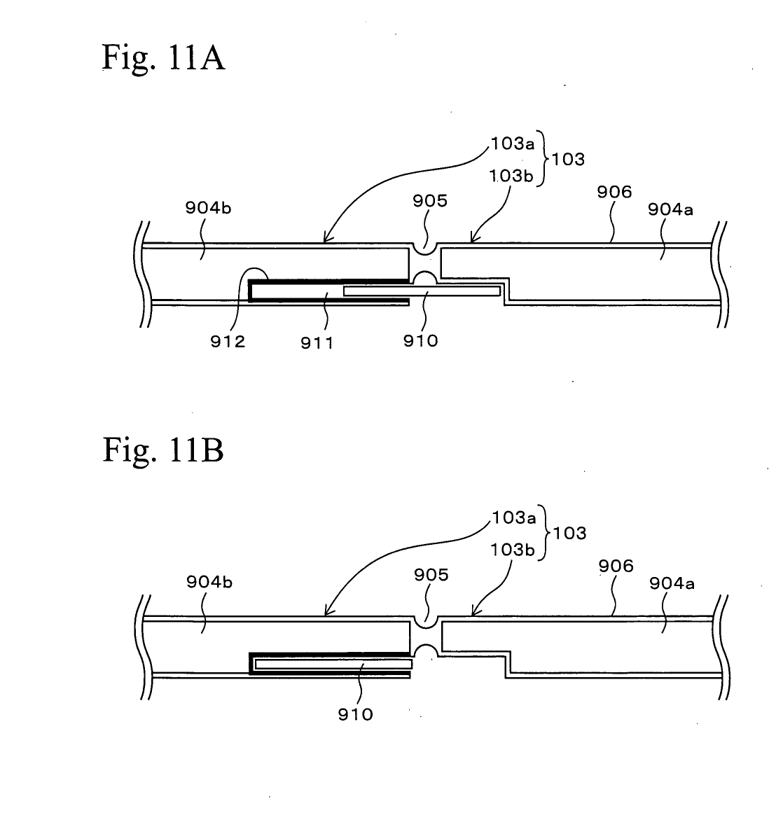

FIGS. 10A and 10B show an example of another formation of a plate member having a structure shown in FIG. 1A, wherein FIG. 10A is a top view and FIG. 10B is a sectional side view. In this example, a first plate member 103a and a second plate member 103b are not separated and are not connected by a hinge. That is, a first board 904a composing a first plate member 103a and a second board 904b composing a second plate member 103b are covered with a fabric 906 by sewing the periphery and folding line 905, at which they are bendable. In this structure, the folding line 905 functions as a connecting member. Note that the fabric 906 may be composed of a resin material and may be welded by a high-frequency welder instead of by sewing. Moreover, the fabric 906 may be bonded by a setting adhesive instead of by sewing.

The first board 904a is mounted with a supporting member 901 by a shaft 902. The supporting member 902 has the shape of a flat plate, and it is rotatable at a surface parallel to the surface of the board. FIG. 10B shows a supporting member 901 which is rotated and projects toward the second plate member 103b. In this case, the supporting member 901, which is mounted to the first board 904a, supports the lower side of the second plate member 103b, so that the second plate member 103b is locked and does not bend downward by gravity. Note that the portions of the first plate member 103a and the second plate member 103b, which correspond to the supporting member 901, are concave (the area represented by reference numeral 907), so that no projecting portion is formed on the lower surface of the plate member 103.

When the supporting member 901 is rotated, and when it is positioned in the lower side of the plate member 103a from the state shown in FIGS. 10A and 10B, the structure for supporting the second plate member 103b from the lower side is lost, whereby the second plate member 103b can be bent down at the folding line 905. Thus, the plate member 103 is folded as shown in FIG. 1B and FIG. 2C.

As a variation of the embodiment, after the plate member 103 is extended, a member of a frame may be inserted into the plate member 103, so as to maintain the flat shape. For example, a structure may be adopted in which a supporting member, which has a plate shape, is linearly shifted from the first plate member 103a to the lower side of the second plate member 103b. In this structure, the second plate member 103b, which is extended, is supported from below, so as not to hang down. An example of this aspect is explained hereinafter. FIGS. 11A and 11B are sectional views showing an example of a structure which supports a second plate member 103b.

In this example, as shown in FIG. 11A, the lower surface of the first plate member 103a is provided with a storage space 911 for stowing a supporting member 911, which has a plate shape. The inside of the storage space 911 has a reinforced structure 912 in order to provide strength thereto. Note that the components represented by the same reference numerals shown in FIGS. 10A and 10B are the same as shown in the figures.

As shown in FIG. 11A, the supporting member 910, which has a plate shape and is stowed in the lower side of the first plate member 103a, is linearly shifted so as to project toward the second plate member 103b. Therefore, the second plate member 103b is supported by the supporting member 910 so as not to hang down. In order to fold the plate member 103, as shown in FIG. 11B, the supporting member 910 is stowed in the storage space 911 of the first plate member 103a. According to this state, the second plate member 103b can be folded down, and the first plate member 103a and the second plate member 103b are folded.

### 3. Third Embodiment

The structure which is exemplified in the second embodiment may be applied to a structure of a plate member exemplified in the first embodiment. In the structure, a plate member is maintained in an extended condition by a supporting member. That is, in a structure comprising a first plate member 103a and a second plate member 103b which are connected by a hinge 104 shown in FIGS. 1A and 2A to 2C, the second plate member 103b may be supported by a supporting member shown in FIGS. 10A, 10B, 11A, and 11B. In this case, the hinge 104 may or may not comprise a lock mechanism for locking the extended state of a plate member.

The present invention may be used for structures of covers to cover luggage compartments of vehicles.

What is claimed is:

1. A tonneau cover apparatus for vehicles, comprising:
a sheet member;
a housing for stowing the sheet member in a rolled up condition;
a first plate member affixed to a leading edge of the sheet member;
a second plate member having a side edge which is connected to the first plate member via a hinge; and
a supporting structure for maintaining the first and the second plate members in a condition in which they are extended on approximately the same surface,
wherein a lower surface of the second plate member is disposed on a lower surface of the first plate member, and an upper surface of the first plate member is disposed on an upper surface of the housing, so that the first and the second plate members are folded with each other, and
when the first and the second plate members are folded, another side edge opposite to the side edge of the second plate member is placed at the leading direction of the sheet member.

2. A tonneau cover apparatus for vehicles, comprising:
a sheet member;
a housing for stowing the sheet member in a rolled up condition;
a first plate member affixed to a leading edge of the sheet member;
a second plate member connected to the first plate member via a connecting member composed of a flexible sheet material; and
a supporting structure for maintaining the first and the second plate members in a condition in which they are extended on approximately the same surface,
wherein a lower surface of the second plate member is disposed on a lower surface of the first plate member, and an upper surface of the first plate member is disposed on the upper surface of the housing, so that the first and the second plate members are folded with each other, and
when the first and the second plate members are folded, another side edge opposite to the side edge of the second plate member is placed at the leading direction of the sheet member.

3. The tonneau cover apparatus for vehicles according to claim 2, wherein a hinge shaft and a hinge are further provided so as to connect the first and the second plate members.

4. The tonneau cover apparatus for vehicles according to claim 1, wherein a handle is provided at another side edge opposite to the side edge of the second plate member, and the handle is placed at the leading direction of the sheet member, when the first and the second plate members are folded.

5. The tonneau cover apparatus for vehicles according to claim 4, wherein the handle is placed on the second plate member at the rear side of a vehicle body when the first and the second plate members are folded.

6. The tonneau cover apparatus for vehicles according to claim 1, wherein the edge of the plate member in the leading direction has a rounded shape.

7. The tonneau cover apparatus for vehicles according to claim 1, wherein the supporting structure has a lock mechanism that maintains the hinge in an opened state.

8. The tonneau cover apparatus for vehicles according to claim 1, wherein the supporting structure comprises a supporting member which upwardly supports the second plate member.

9. The tonneau cover apparatus for vehicles according to claim 1, wherein a fastener with hooks and loops is provided at the lower surfaces of the first and the second plate members, and the fastener with hooks and loops adheres the first and the second plate members when they are folded.

10. The tonneau cover apparatus for vehicles according to claim 2, wherein a handle is provided at another side edge opposite to the side edge of the second plate member, and the handle is placed at the leading direction of the sheet member, when the first and the second plate members are folded.

11. The tonneau cover apparatus for vehicles according to claim 10, wherein the handle is placed on the second plate member at the rear side of a vehicle body when the first and the second plate members are folded.

12. The tonneau cover apparatus for vehicles according to claim 2, wherein the edge of the plate member in the leading direction has a rounded shape.

13. The tonneau cover apparatus for vehicles according to claim 2, wherein the supporting structure has a lock mechanism that maintains the hinge in an opened state.

14. The tonneau cover apparatus for vehicles according to claim 2, wherein the supporting structure comprises a supporting member which upwardly supports the second plate member.

15. The tonneau cover apparatus for vehicles according to claim 2, wherein a fastener with hooks and loops is provided at the lower surfaces of the first and the second plate members, and the fastener with hooks and loops adheres the first and the second plate members when they are folded.
